(19) United States
(12) Patent Application Publication
(10) Pub. No.: US 2020/0216094 A1
(43) Pub. Date: Jul. 9, 2020

(54) PERSONAL DRIVING STYLE LEARNING FOR AUTONOMOUS DRIVING

(71) Applicant: Futurewei Technologies, Inc., Plano, TX (US)

(72) Inventors: Jiafeng Zhu, Pleasanton, CA (US); Hong Zhang, Palo Alto, CA (US)

(21) Appl. No.: 16/825,886

(22) Filed: Mar. 20, 2020

Related U.S. Application Data
(63) Continuation of application No. PCT/CN2019/084068, filed on Apr. 24, 2019.
(60) Provisional application No. 62/777,655, filed on Dec. 10, 2018.

(51) Int. Cl. B60W 60/00; G05D 1/00; G06N 20/00

(52) U.S. Cl. CPC B60W 60/0013; G05D 1/0088; G06N 20/00; B60W 2520/10; B60W 2520/105; B60W 2510/18; B60W 2540/223; B60W 2540/215; B60W 2540/30; B60W 2540/21; B60W 2556/10; B60W 2556/45; B60W 2510/20

(57) ABSTRACT

Operation of an autonomous vehicle is modified based on the driving style preferences of a passenger. A machine learning module for a motion planner of the autonomous vehicle accepts input relating to driving style of the autonomous vehicle including data representing autonomous vehicle speed, acceleration, braking, or steering during operation. The passenger also provides feedback relating to the vehicle's driving style during operation, and the passenger feedback is used to train the machine learning module to create a personal driving style decision-making model for the passenger that controls operation of the autonomous vehicle. A personal driving style preference profile for the passenger also may be obtained by collecting motion sensor data relating to driving habits of the passenger when the passenger is a driver. The driving style preference profile is used by the motion planner to modify operation of the autonomous vehicle in accordance with the driving style preference profile.

### CROSS REFERENCE TO RELATED APPLICATIONS

This application claims priority to PCT/CN2019/084068 filed Apr. 24, 2019, which claims priority to U.S. Provisional Application 62/777,655, filed Dec. 10, 2018, both entitled “Personal Driving Style Learning for Autonomous Driving” and both of which are hereby incorporated by reference in their entireties.

### TECHNICAL FIELD

This application generally relates to autonomous driving technologies, and more specifically, to a motion controlling system and method for an autonomous vehicle.

### BACKGROUND

As used herein, an “autonomous vehicle” refers to a so-called level 4 autonomous vehicle that is capable of sensing its environment and navigating without human input. Such autonomous vehicles can detect their surroundings using a variety of techniques, and autonomous control systems in the autonomous vehicles interpret sensory information to identify appropriate navigation paths.

Autonomous vehicles include sensors that provide input to a motion planner to control the vehicle operation. The motion planner controls the vehicle to drive safely based on the sensed operating conditions but does not account for the comfort level of the passenger during vehicle operation, which is generally a subjective personal feeling. Prior art motion planners generally do not account for subjective passenger preferences relating to driving style of the autonomous vehicle. For example, the autonomous vehicle typically responds to sensor inputs to stay on a route, to avoid obstacles, and to adjust to weather conditions. However, the autonomous vehicle does not slow down or adjust acceleration, etc. based on passenger preference. An autonomous vehicle manufacturer cannot design an autonomous vehicle that would drive satisfactorily for every passenger as the preferences of the individual passengers are unknowable at the time of manufacture and, in any case, vary from passenger to passenger. Moreover, even the same passenger has different comfort level requirements under different driving conditions. An autonomous vehicle generally does not know these comfort level requirements for the different conditions a passenger may encounter while riding in the autonomous vehicle and thus may not adjust to them. A manufacturer of an autonomous vehicle cannot design a motion planner for an autonomous vehicle that is suitable for all passengers under all conditions due to the subjective differences from one passenger to another.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

Systems and methods described herein provide a driving style module for the motion planner of an autonomous vehicle where the driving style module provides driving control parameters that are unique to the individual. In sample embodiments, the driving style module may be modified to express the driving preferences of one or more passengers in an autonomous vehicle. The driving style module may include a driving style preference profile of a passenger as well as a machine learning model to adjust the driving parameters over time based on passenger feedback.

The systems and methods described herein include at least two main features. In accordance with the first feature, motion sensor data relating to the driving habits of a driver are collected to create a driving style preference profile of the driver and the driving data (video, motions) is used to train a driving style model. After training, this driving style model is stored in a driving style module. During operation of the autonomous vehicle, the driving style preference profile from the driving style module is provided to the motion planner of the autonomous vehicle to modify operation of the autonomous vehicle in accordance with the driving style preference profile. In accordance with the second feature, a machine learning module is provided to enable the motion planner of the autonomous vehicle to accept passenger input relating to the driving style of the autonomous vehicle where the driving style input includes data representing autonomous vehicle speed, acceleration, braking, steering, etc. during operation. The passenger input is provided in the form of feedback relating to the driving style of the autonomous vehicle. The passenger feedback is used to continuously train/update the machine learning module to create a personal driving style decision-making model for the passenger that controls operation of the autonomous vehicle. During operation, the motion planner provides a range of safe operation commands according to the concurrent driving conditions. For example, the motion planner may adjust the acceleration range (0 to 60 in 4 seconds, 5 seconds, 6 seconds, etc.) based on the passenger's personal driving style preference profile to make an acceleration choice within the safe command range that is consistent with the passenger's personal driving style preference profile. In sample embodiments, the motion planner provides a driving command with a safe range and the driving style model selects values in the safe range to meet the passenger's preference.

According to a first aspect of the present disclosure, a computer-implemented method of modifying operation of an autonomous vehicle based on driving style decision-making model of a passenger is provided. The method includes a machine learning module for a motion planner of the autonomous vehicle accepts input relating to driving style of the autonomous vehicle. The driving style input includes data representing at least one of autonomous vehicle speed, acceleration, braking, and steering during operation. The machine learning module of the motion planner of the autonomous vehicle also receives passenger feedback during operation. The passenger feedback relates to the driving style of the autonomous vehicle. The passenger feedback trains the machine learning module to create a personal driving style decision-making model for the passenger, and operation of the autonomous vehicle is controlled using the personal driving style decision-making model for the passenger.

According to a second aspect of the present disclosure, a computer-implemented method of modifying operation of an autonomous vehicle based on driving style preference profile of a passenger is provided that includes collecting motion sensor data relating to driving habits of a driver to create a driving style preference profile of the driver, storing the driving style preference profile in a driving style module, and providing the driving style preference profile from the driving style module to a motion planner of the autonomous vehicle to modify operation of the autonomous vehicle in accordance with the driving style preference profile.

According to a third aspect of the present disclosure, there is provided an autonomous vehicle control system that modifies operation of an autonomous vehicle based on driving style preference profile of a passenger. The autonomous vehicle control system includes motion sensors that provide motion sensor data relating to driving habits of a driver, a processor that creates a driving style preference profile of the driver from the motion sensor data, a driving style module that stores the driving style preference profile, and a motion planner that receives the driving style preference profile from the driving style module and modifies operation of the autonomous vehicle in accordance with the driving style preference profile.

According to a fourth aspect of the present disclosure, there is provided a non-transitory computer-readable media storing computer instructions for modifying operation of an autonomous vehicle based on driving style preference profile of a passenger, that when executed by one or more processors, cause the one or more processors to perform the steps of collecting motion sensor data relating to driving habits of a driver to create a driving style preference profile of the driver, storing the driving style preference profile in a driving style module, and providing the driving style preference profile from the driving style module to a motion planner of the autonomous vehicle to modify operation of the autonomous vehicle in accordance with the driving style preference profile.

In a first implementation of any of the preceding aspects, the passenger feedback is provided by voice, a touch screen, smart phone input, a vehicle interior sensor, and/or a wearable sensor on the passenger, and the feedback relates to autonomous vehicle speed, acceleration, braking, and/or steering during operation and/or passenger comfort/discomfort during autonomous vehicle operation.

In a second implementation of any of the preceding aspects, the passenger feedback adjusts a cost function of the machine learning module.

In a third implementation of any of the preceding aspects, the machine learning module receives parameters of the personal driving style decision-making model from the passenger before or during operation of the autonomous vehicle and the machine learning module modifies the personal driving style decision-making model based on passenger feedback during operation of the autonomous vehicle.

In a fourth implementation of any of the preceding aspects, the method further includes recognizing a passenger in the autonomous vehicle and loading the parameters of the personal driving style decision-making model from the recognized passenger into the machine learning module.

In a fifth implementation of any of the preceding aspects, the parameters of the personal driving style decision-making model are stored in a memory storage device of the passenger and are communicated to the machine learning module from the memory storage device.

In a sixth implementation of any of the preceding aspects, the memory storage device/driving style module comprises at least one of a key fob, a smart phone, and a cloud-based memory.

In a seventh implementation of any of the preceding aspects, the method further comprises a machine learning module for the motion planner of the autonomous vehicle accepting as input the driving style preference profile and input relating to driving style of the autonomous vehicle, where the driving style input comprises data representing at least one of autonomous vehicle speed, acceleration, braking, and steering during operation; the machine learning module of the motion planner of the autonomous vehicle receiving passenger feedback during operation, the passenger feedback relating to the driving style of the autonomous vehicle; and training the machine learning module using the driving style preference profile and passenger feedback to create a personal driving style decision-making model for the passenger.

The method can be performed and the instructions on the computer readable media may be processed by one or more processors associated with the motion planner of an autonomous vehicle, and further features of the method and instructions on the computer readable media result from the functionality of the motion planner Also, the explanations provided for each aspect and its implementation apply equally to the other aspects and the corresponding implementations. The different embodiments may be implemented in hardware, software, or any combination thereof. Also, any one of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates a block diagram of a conventional autonomous vehicle driving control architecture.

FIG. 2 illustrates the inputs to a conventional motion planner of a conventional autonomous vehicle.

FIG. 3 illustrates a schematic diagram of a computing device of an autonomous vehicle in a sample embodiment.

FIG. 4 illustrates a sample embodiment of a machine learning module.

FIG. 5 illustrates a block diagram of an autonomous vehicle driving control architecture adapted to include a personal driving style module in a sample embodiment.

FIG. 6 illustrates a flow chart of a method of modifying operation of an autonomous vehicle based on driving style of a passenger in accordance with a first sample embodiment.

FIG. 7 illustrates a flow chart of a method of modifying operation of an autonomous vehicle based on driving style of a passenger in accordance with a second sample embodiment.

FIG. 8 is a block diagram illustrating circuitry in the form of a processing system for implementing the systems and methods of providing a personalized driving style module to an autonomous vehicle according to sample embodiments.

### DETAILED DESCRIPTION

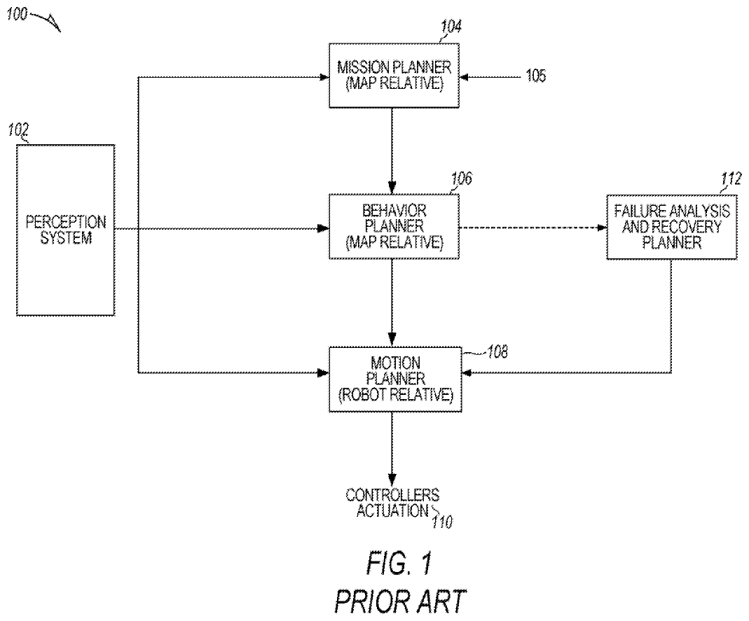

It should be understood at the outset that although an illustrative implementation of one or more embodiments are provided below, the disclosed systems and/or methods described with respect to FIGS. 1-8 may be implemented using any number of techniques, whether currently known or in existence. The disclosure should in no way be limited to the illustrative implementations, drawings, and techniques illustrated below, including the example designs and implementations illustrated and described herein, but may be modified within the scope of the appended claims along with their full scope of equivalents.

The systems and methods described herein enable a passenger's ride in an autonomous vehicle to be customized based on the driving style of the passenger by storing a driving style model for the passenger in the passenger's smart devices (key fob, smart phone, or others) or in the cloud. When the passenger enters an autonomous vehicle, the driving style preference profile is loaded into the autonomous vehicle (taxi, rental, or sharing vehicle) so that the autonomous vehicle will operate in accordance with the passenger's driving preferences. Alternatively, if the autonomous vehicle is owned by the passenger, the passenger's driving style preference profile may be loaded directly into the autonomous vehicle. In either case, the driving style preference profile may be updated based on user actions and responses while riding in the autonomous vehicle. The actions may be direct user inputs to the autonomous vehicle or actions that are sensed by the autonomous vehicle using the appropriate sensors.

FIG. 1 illustrates a conventional autonomous vehicle driving control architecture 100. As illustrated, the autonomous vehicle driving control architecture 100 includes a perception system 102 that includes a number of sensors that perceives the environment around the autonomous vehicle and provides control inputs to the respective functional units of the autonomous vehicle driving control architecture 100. For example, object types and locations as well as map-based localization and absolute localization data are provided to a mission planner 104 along with map attributes such as lanes, lane waypoints, mission waypoints, etc. 105 to enable the mission planner 104 to calculate the next mission waypoint, to select behaviors, etc. The calculated next long range (on the order of kilometers) mission waypoint and selected behaviors are provided with the object types and locations as well as map-based localization and absolute localization data from the perception system 102 to a behavioral planner 106 that calculates coarse maneuver selections and motion planning constraints. The behavioral planner 106 also calculates the next short range (on the order of 50-100 meters) waypoint. The calculated coarse maneuver selections, motion planning constraints, and the calculated next short-range waypoint data are provided to the motion planner 108 along with object data and road constraint data from the perception system 102 to calculate the controls for the autonomous vehicle, including the desired vehicle speed and direction. The calculated controls 110 are used to control the appropriate actuators of the autonomous vehicle in a conventional manner If the behavioral planner 106 fails for any reason, the failure analysis and recover planner 112 provides control inputs to the motion planner 108 to take appropriate actions such as pulling the autonomous vehicle safely to the side of the road and halting further movement until corrective action can be taken.

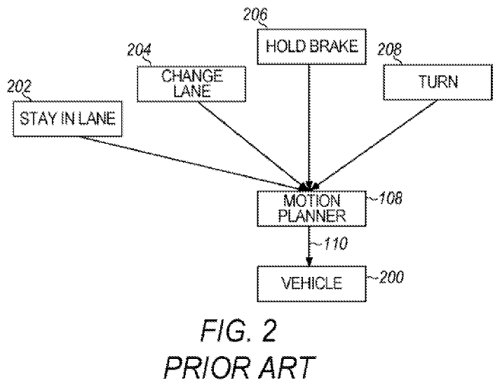

FIG. 2 illustrates sample inputs to the conventional motion planner 108 of FIG. 1 for controlling a conventional autonomous vehicle 200. Generally, as noted above, the controls 110 to the autonomous vehicle 200 include the desired speed, curvature, acceleration, etc., and these values are used to control the appropriate actuators for controlling operation of the autonomous vehicle 200. As illustrated, the control inputs to the motion planner may include a subset of data such as stay-in-lane 202, change lane 204, hold brake 206, turn 208, etc.

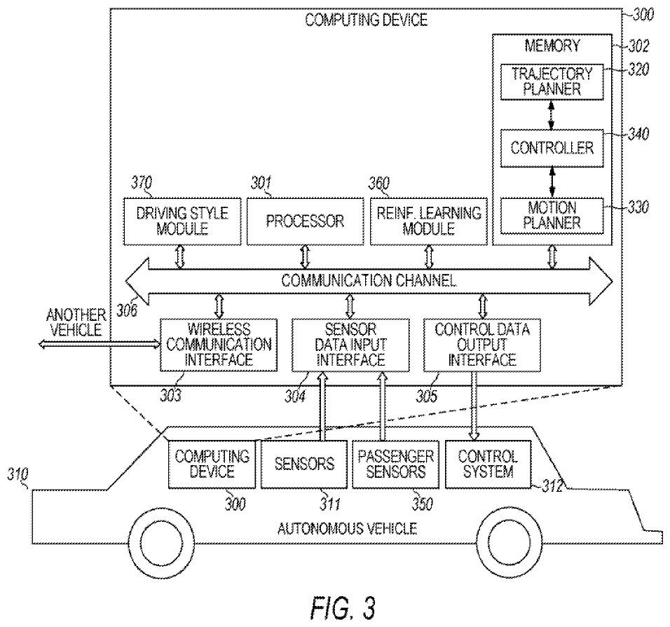

FIG. 3 illustrates a schematic diagram of a computing device 300 that is equipped in or communicatively coupled with an autonomous vehicle 310 in accordance with one embodiment of the present disclosure. Autonomous vehicle 310 may be any type of vehicle including, but not limited to, cars, trucks, motorcycles, busses, recreational vehicles, amusement park vehicles, farm equipment, construction equipment, trams, and golf carts.

As shown in FIG. 3, computing device 300 is coupled with a set of sensors 311. Sensors 311 may include, but not limited to, cameras to input perceptions of road conditions, radar/lidar units, microphones, laser units, etc. Sensors 311 may also include a geographic location device, such as a Global Positioning System (GPS) receiver, used for determining the latitude, longitude, and/or altitude position of autonomous vehicle 310. Other location devices such as a laser-based localization device, inertial-aided GPS, or camera-based localization device coupled with sensors 311 may also be used to identify the location of autonomous vehicle 310. The location information of autonomous vehicle 310 may include absolute geographical location information, such as latitude and longitude, as well as relative location information, such as location relative to other vehicles in the vicinity of the autonomous vehicle.

Sensors 311 may also provide current environment information to computing device 300. For example, when an unexpected obstacle appears in front of autonomous vehicle 310, sensors 311 collect current environment information related to the unexpected obstacle and provide the collected environment information to computing device 300. The collected environment information may include the size of the obstacle, the moving direction of the obstacle, and the speed of the obstacle.

Computing device 300 is also coupled with control system 312 of autonomous vehicle 310. The computing device 300 and control system 312 may be powered by a storage battery or a solar battery of autonomous vehicle 300. Computing device 300 implements a motion control method to guide autonomous vehicle 310 along a path and to provide motion information (e.g., path information including poses) to control system 312 of autonomous vehicle 310. Control system 312 of autonomous vehicle 310 controls the driving of autonomous vehicle 310 according to the received motion and actuator control information.

As shown in FIG. 3, computing device 300 may include processor 301, memory 302, wireless communication interface 303, sensor data input interface 304, control data output interface 305, and communication channel 306. Processor 301, memory 302, wireless communication interface 303, sensor data input interface 304, and control data output interface 305 are communicatively coupled with each other through communication channel 306. Communication channel 306 includes, but not limited to, a bus that supports FlexRay, Controller Area Network (CAN), and Shared cable Ethernet. Computing device 300 may also include other devices typically present in a general-purpose computer.

Sensor data input interface 304 is coupled with sensors 311 of autonomous vehicle 310 and configured to receive location information generated by sensors 311. Control data output interface 305 is coupled with control system 312 of autonomous vehicle 310 and configured to provide motion and actuator control information generated by computing device 300 to control system 312. Control system 312 controls the moving direction and the speed of autonomous vehicle 310 according to the received motion and actuator control information generated by computing device 300.

Wireless communication interface 303 is configured to communicate with other vehicles and sensors using wireless signals. The wireless signals transmitted among wireless communication interface 303 and other vehicles/sensors are carried by the 802.11p protocol developed for dedicated short-range communications (DSRC). Wireless communication interface 303 may also use other protocols including, for example, Long-Term Evolution (LTE) or 5th generation wireless systems to transmit wireless signals.

Processor 301 may be any conventional one or more processors, including Reduced Instruction Set Computing (RISC) processors, Complex Instruction Set Computing (CISC) processors, or combinations of the foregoing. Alternatively, processor 301 may be a dedicated device such as an application-specific integrated circuit (ASIC). Processor 301 is configured to execute instructions stored in memory 302.

Memory 302 may store information accessible by processor 301, such as instructions and data that may be executed or otherwise used by processor 301. Memory 302 may be of any type of memory operative to store information accessible by processor 301, including a computer-readable medium, or other medium that stores data that may be read with the aid of an electronic device. Examples of memory 302 include, but are not limited to, a hard-drive, a memory card, read-only memory (ROM), random-access memory (RAM), digital video disc (DVD), or other optical disks, as well as other write-capable and read-only memories. Systems and methods may include different combinations of the foregoing, whereby different portions of the instructions and data are stored on different types of media.

The instructions stored in memory 302 may be any set of instructions executed directly, such as machine code, or indirectly, such as scripts, by processor 301. For example, the instructions may be stored as computer code on the computer-readable medium. In that regard, the terms “instructions” and “programs” may be used interchangeably herein. The instructions may be stored in object code format for direct processing by processor 301, or in any other computer language including scripts or collections of independent source code modules that are interpreted on demand or compiled in advance. Functions, methods and routines of the instructions are explained in more detail in U.S. Publication No. 2018/0143641, the contents of which are incorporated herein by reference.

Motion information generated by computing device 300 includes two kinds of motion information, namely, high level motion information and low-level motion information. The motion information indicates ongoing movement for autonomous vehicle 310.

FIG. 3 further illustrates a logical function block diagram of an application process that is generated by processor 302 when executing the instructions stored in memory 301. The application process includes at least three functional modules, namely, a trajectory planner 320, a motion planner 330, and a controller 340. Trajectory planner 320 is configured to generate high level motion information for autonomous vehicle 310 based on the input information received and a preset trajectory generation algorithm. The input information received by trajectory planner 320 includes a start point, a current position, a destination, navigation information, and environment information. The navigation information includes map data. The environment information includes traffic statistical data and static obstacle data. The trajectory generation algorithm includes a Dynamic Programming (DP) method that is used by trajectory planner 320 to generate multiple possible paths according to the input information. Each path generated by trajectory planner 320 includes a sequence of waypoints. Each waypoint has a position value that is expressed by p(x, y), where the symbol x in p(x, y) indicates a value on the horizontal axis of the map, and the symbol y in p(x, y) indicates a value on the vertical axis of the map. A distance between two neighboring waypoints is about 50 meters to 150 meters.

In sample embodiments, trajectory planner 320 receives a start point, a current position (coarse position value), destination, navigation information, and environment information and outputs a selected path including the detailed current position value and next waypoint to the motion planner 330. Motion planner 330 outputs the path information including a plurality of poses for use in controlling the operation of the autonomous vehicle.

Trajectory planner 320 may communicate with controller 340 multiple times when autonomous vehicle 310 moves from the start point to the destination. In this situation, the start point in the input information is replaced by the current position of the autonomous vehicle 310. The current position of autonomous vehicle 310 is indicated by a coarse position value provided by sensors 311. The coarse position value indicates a position located in a segment constructed by two consecutive waypoints in a map. After controller 340 inputs a coarse position value indicating the current position of autonomous vehicle 310 to trajectory planner 320, trajectory planner 320 may calculate multiple possible paths for each coarse position value received based on other input constraints, e.g., a static obstacle, and each of the multiple possible paths starts with a waypoint close to the current position and ends at the destination. Then trajectory planner 320 selects a path from the multiple possible paths according to the preset policy. Trajectory planner 320 further determines a waypoint that is closest to the current position and on the selected path. Trajectory planner 320 outputs the selected path and the determined waypoint as the high-level motion information.

The waypoint closest to the current position and on the selected path is called as a “next waypoint.” The next waypoint is regarded as a destination for the autonomous vehicle 310 to arrive in a shortest controlling period. In other words, the next waypoint is a destination for the current low-level path planning The next waypoint may be used by motion planner 330 as input for generating low-level motion information. The low-level path planning provides low-level motion information for the autonomous vehicle 310 to arrive at the next waypoint.

Motion planner 330 is configured to generate low-level motion information for autonomous vehicle 310 based on the detailed position values provided by sensors 311, the next waypoint generated by trajectory planner 320, and the preset motion generation algorithm. Sometimes the input information received by motion planner 330 further includes obstacle information provided by sensors 311. The obstacle may be a static obstacle or a moving obstacle. When the obstacle is a static obstacle, the obstacle information includes detailed position information including shape, size, etc. When the obstacle is a moving obstacle, such as a vehicle on the road, the obstacle information includes detailed position information, heading value, speed value, etc. The preset motion generation algorithm includes Hybrid A*, A*, D* and R* that together generate low-level motion information for controlling the operation of the autonomous vehicle 310.

For a set of input information, motion planner 330 calculates the path information based on a current position of autonomous vehicle 310 and the next waypoint received. The path information includes a plurality of poses, which enables autonomous vehicle 310 to move from the position indicated by the current position value of the autonomous vehicle 310 to the next waypoint received step by step. The data structure of each pose is expressed as a vector P (p(x, y), s(x, y), h(θ)). The p(x, y) in vector P indicates a position value in the path. For example, the symbol x in p(x,y) indicates a value in the horizontal axis of the map, and the symbol y in p(x, y) indicates a value in the vertical axis of the map. The s(x, y) in vector P indicates a speed of autonomous vehicle 310 in the horizontal axis and the vertical axis, respectively. The h(θ) in vector P indicates the movement direction of autonomous vehicle 310. Motion planner 330 outputs the path information that includes a plurality of poses as the low-level motion information.

In order to control the movement of autonomous vehicle 310 accurately, a number of poses output by motion planner 330 is determined based on the approximate moving speed of autonomous vehicle 310 and a preset requirement. For example, the preset requirement may be that 10 poses are required for each second movement of autonomous vehicle 310. In one example, the distance between the current position indicated by the detailed current position value of autonomous vehicle 310 and the next waypoint generated by trajectory planner 320 is about 100 meters, and the approximate moving speed of autonomous vehicle 310 is 36 km/h (10 m/s). Thus, autonomous vehicle 310 needs 10 seconds to move from the current position to the next waypoint generated by trajectory planner 320, and motion planner 320 needs to output 100 poses.

Controller 340 is configured to receive data sent from sensors 311 and to determine whether a target vehicle is on a route of autonomous vehicle 310 to a next waypoint according to the data sent from sensors 311 and preset algorithms. Controller 340 is further configured to communicate with trajectory planner 320 and motion planner 330 based on different input information and different road conditions. Controller 340 may be further configured to communicate with the target vehicle through the wireless communication interface 303.

In sample embodiments, an autonomous vehicle of the type described above is further modified to collect driving style data. The driving style data is collected to learn the driving habits of the driver and then to use that data to set the driving style of the autonomous vehicle. Generally, the driving style of an autonomous vehicle is not set by the manufacturer and no mechanism is provided for customizing the driving style of the autonomous vehicle to the preferences of the driver/passenger. The driving style data is collected from sensors 311 as well as passenger sensors 350 including motion sensors in accelerometers, gyroscopic data in a smartphone application, a mobile phone camera, sensors mounted in the vehicle to sense the condition of the passenger, or camera accessory data. The collected driving style data contains, for example, driving video, motion data, timestamp data, and the like. The accelerometer may further measure linear acceleration of movement in the x, y, and z directions, while the gyroscope measures the angular rotational velocity and the camera provides road and weather conditions. Lidar and other sensor inputs may also be collected as part of the driving style data.

In the sample embodiments, the collected driving style data represents the driving conditions when the vehicle is not in autonomous mode. In other words, the collected driving data includes the driving parameters collected when the passenger is driving the vehicle. However, the driving data may also include the driving parameters collected during autonomous driving as adjusted by passenger feedback in the form of commands to speed up, slow down, accelerate more slowly, etc. In sample embodiments, the passenger feedback may be provided by a smartphone application, passenger instructions received by a voice recognition device, and/or control inputs provided via a passenger touchscreen interface in the vehicle. The passenger feedback may also be collected passively using sensors within the vehicle or from passenger wearable devices that measure the passenger's blood pressure, heart rate, and other biological data representative of the comfort level of the passenger. The driving style data so collected is provided to a machine learning module 360 that may be part of computer 300 as illustrated or may be located in the user's smartphone or other computer device, or in the cloud. The machine learning module 360 receives and processes the driving style data to train a personal driving style decision making model.

When training the personal driving style decision making model, the passenger input (from sensors or direct passenger feedback) is treated as a cost reward function for driving data abstracts in a reinforcement learning model. The passenger would be enabled to annotate the current driving state with a pre-defined selection set such as “like,” “dislike,” “too fast,” “too slow,” “fear,” “car sick,” and the like. The reinforcement learning driving style model would continuously be updated as the passenger rides in the vehicle as a passenger and, where available, as the passenger drives the vehicle. Once the driving style model is trained, the driving style model size may be reduced and training only operators are removed from the driving style model. The driving style model may then be fixed at the smaller size and stored to a device. For example, the driving style model would be stored in a driving style module 370 and used to control operation of the autonomous vehicle, subject to continued passenger feedback and updating of the driving style model. The driving style module 370 may remain with the vehicle or may be portable so that the passenger may provide a personalized driving style module 370 to each autonomous vehicle upon taking a ride. For example, the driving style module 370 may be stored in a fob, the passenger's smartphone, or may be stored in the cloud and accessible upon demand. Of course, where the passenger's driving style may conflict with optimal driving practice, the autonomous vehicle would override the driving style model to prioritize the passenger's safety. In sample embodiments, the motion planner provides a driving command with a safe range and the driving style model selects values in the safe range to meet the passenger's preference.

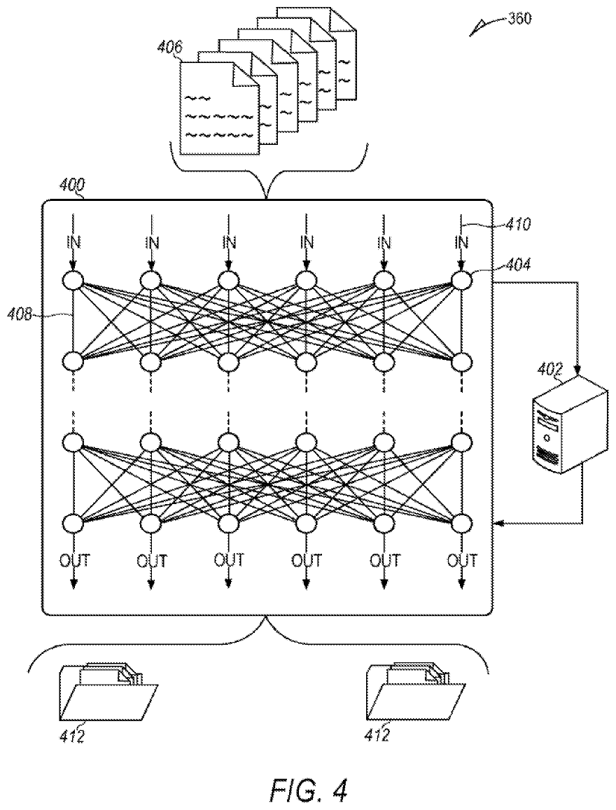

FIG. 4 illustrates a sample embodiment of a machine learning module. A machine learning module is an artificial intelligence (AI) decision-making system that may be adapted to perform cognitive tasks that have traditionally required a living actor, such as a person. Machine learning modules may include artificial neural networks (ANNs), which are computational structures that are loosely modeled on biological neurons. Generally, ANNs encode information (e.g., data or decision-making) via weighted connections (e.g., synapses) between nodes (e.g., neurons). Modern ANNs are foundational to many AI applications, such as automated perception (e.g., computer vision, speech recognition, contextual awareness, etc.), automated cognition (e.g., decision-making, logistics, routing, supply chain optimization, etc.), and automated control (e.g., autonomous cars, drones, robots, etc.), among others.

Many ANNs are represented as matrices of weights that correspond to the modeled connections. ANNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the ANN graph—if the threshold is not exceeded then, generally, the value is not transmitted to a down-graph neuron and the synaptic connection remains inactive. The process of weighting and testing continues until an output neuron is reached. The pattern and values of the output neurons constitute the result of the ANN processing.

The correct operation of most ANNs relies on correct weights. However, ANN designers do not generally know which weights will work for a given application. Instead, a training process is used to arrive at appropriate weights. ANN designers typically choose a number of neuron layers or specific connections between layers including circular connections, but the ANN designer does not generally know which weights will work for a given application. Instead, a training process generally proceeds by selecting initial weights, which may be randomly selected. Training data is fed into the ANN and results are compared to an objective function that provides an indication of error. The error indication is a measure of how wrong the ANN' s result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the ANN—here “forward” means that the data starts at the input neurons and follows the directed graph of neuron connections until the output neurons are reached—and the objective function is applied backwards through the ANN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of ANNs.

FIG. 4 illustrates an example of an environment including a system for neural network training, according to an embodiment. The system includes an ANN 400 that is trained using a processing node 402. The processing node 402 may be a CPU, GPU, field programmable gate array (FPGA), digital signal processor (DSP), application specific integrated circuit (ASIC), or other processing circuitry such as processor 301 of FIG. 3. In an example, multiple processing nodes may be employed to train different layers of the ANN 400, or even different nodes 404 within layers. Thus, a set of processing nodes 404 is arranged to perform the training of the ANN 400.

The set of processing nodes 404 is arranged to receive a training set 406 for the ANN 400. The ANN 400 comprises a set of nodes 404 arranged in layers (illustrated as rows of nodes 404) and a set of inter-node weights 408 (e.g., parameters) between nodes 404 in the set of nodes 404. In an example, the training set 406 is a subset of a complete training set. Here, the subset may enable processing nodes 404 with limited storage resources to participate in training the ANN 400.

The training data may include multiple numerical values representative of a domain, such as the driving style parameters mentioned above. Each value of the training, or input 410 to be classified once ANN 400 is trained, is provided to a corresponding node 404 in the first layer or input layer of ANN 400. The values propagate through the layers and are changed by the objective function.

As noted above, the set of processing nodes 404 is arranged to train the neural network to create a trained neural network. Once trained, data input into the ANN 400 will produce valid classifications 412 (e.g., the input data 410 will be assigned into categories), for example. The training performed by the set of processing nodes 404 is iterative. In an example, each iteration of the training of the neural network is performed independently between layers of the ANN 400. Thus, two distinct layers may be processed in parallel by different members of the set of processing nodes 404. In an example, different layers of the ANN 400 are trained on different hardware. The members of different members of the set of processing nodes 404 may be located in different packages, housings, computers, cloud-based resources, etc. In an example, each iteration of the training is performed independently between nodes 404 in the set of nodes 404. In an example, the nodes 404 are trained on different hardware.

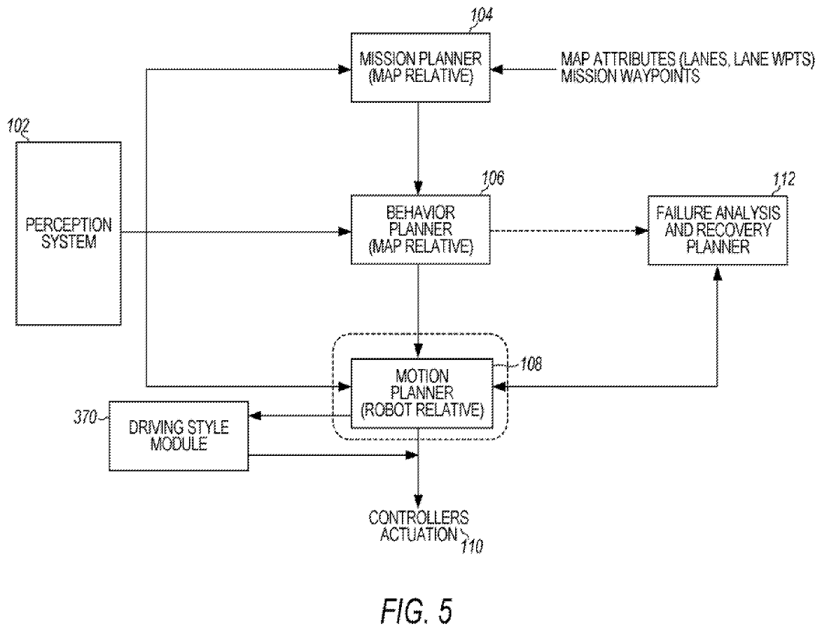

The driving style parameters collected during driving by the passenger or driving by the autonomous vehicle with feedback from the passenger is thus provided to the machine learning module 360 illustrated in FIG. 4 to provide classifications 412 that become the driving style model for the passenger. This driving style model is stored in driving style module 370 and used to modify the operation of the motion planner 330 to reflect the preferences and comfort levels of the passenger as reflected by the parameters stored in the driving style module 370. For example, as illustrated in FIG. 5, the driving style module 370, which has been trained by the passenger's driving style parameters, is connected to the autonomous vehicle control system to provide the driving style parameters to the motion planner 108 for modifying the actuation parameters 110 to reflect the driving style of the passenger.

As noted above, the driving style module 370 may remain with the vehicle or may be stored in a memory device such as a fob, smartphone, or accessible cloud memory for use when the passenger is riding in autonomous vehicle 310. The driving style module may be plugged in or the data may be transmitted to the computer 300 via the sensor data input interface 304 of the wireless communication interface 303, as desired. Alternatively, the sensors 370 in the autonomous vehicle 310 may recognize the passenger from a key fob, log in data, via facial recognition, iris recognition, voice recognition, and the like and automatically download the driving style parameters of the driver (passenger) from the driving style module 370. If uncertain, the system may ask the passenger to identify himself and/or to plug in the driving style module 370 or otherwise provide the driving style parameters. The cost functions of the machine learning module 360 would continue to be modified during vehicle operation based on direct passenger feedback or passive feedback from heart rate detectors and the like, and the driving style model would be modified and the driving style module 370 updated accordingly.

It is recognized that for a commercial autonomous vehicle to satisfy a passenger's comfort level, the commercial autonomous vehicle must be adaptable as one driving style model would not satisfy all passengers. In such situations, the driving style module 370 would be trained over time as described above and the driving style module 370 would be injected into the motion planner 108 when the passenger is riding in the autonomous vehicle. The parameters of the driving control model stored in the driving control module 370 would then be used by the motion planner 108 to generate the actuation parameters 110 for the autonomous vehicle. In this fashion, the personal driving style module 370 would inject personalized driving style parameters into self-driving cars, family cars, commercial shared cars, taxis, and the like. In sample embodiments, the personal driving style module 370 would be trained and stored in the passenger's mobile phone or key fob and then loaded into the motion planner 108 of the autonomous vehicle before a trip is started. As appropriate, the driving style module could be shared among different passengers of the autonomous vehicle 310.

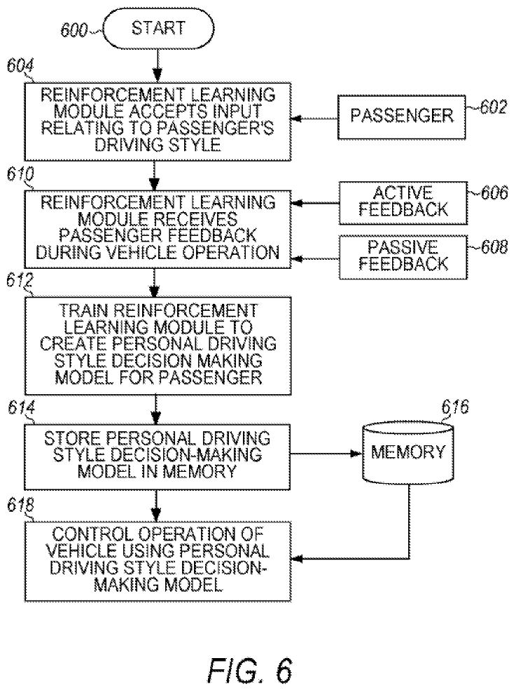

FIG. 6 illustrates a flow chart of a method of modifying operation of an autonomous vehicle based on driving style of a passenger in accordance with a first sample embodiment. The illustrated process may be implemented entirely on processor 301 (FIG. 3) or the training process may be implemented off-line to create a personalized driving style module 370 that is communicated to the autonomous vehicle 310 for implementation of appropriate control operations during operation. As illustrated, the process begins at 600 by the passenger identifying himself at 602 based on input to an input device, recognition of a key fob, a communication from the passenger's smartphone, and/or by sensory recognition of the passenger using facial recognition, voice recognition, iris recognition, or other identification techniques. Once the passenger is identified, the machine learning module 360 for a motion planner 330 of the autonomous vehicle 310 accepts input relating to the passenger's driving style at 604. In sample embodiments, the driving style input includes data representing vehicle speed, acceleration, braking, and/or steering during operation. During operation, the machine learning module 360 of the motion planner 330 of the autonomous vehicle 310 also may receive passenger feedback relating to the driving style of the autonomous vehicle 310. In sample embodiments, the feedback data may be active feedback data 606 provided by the passenger by voice, a touch screen, smart phone input, and the like at sensor data input interface 304 and/or passive feedback data 608 collected from the passenger by sensors 350 such as a camera, a passenger wearable device, a vehicle interior sensor, and the like. The feedback relates to autonomous vehicle speed, acceleration, braking, and steering during operation and passenger comfort/discomfort during autonomous vehicle operation. The feedback data is received by the machine learning module 360 during operation at 610 and is used to adjust the cost function to train the machine learning module 360 at 612 to create a personal driving style decision-making model for the passenger. The personal driving style decision-making model is stored at 614 in a memory 616 that may include a key fob, a smartphone, a cloud-based memory device, and the like. At 618, the operation of the autonomous vehicle is controlled using the personal driving style decision-making model for the passenger.

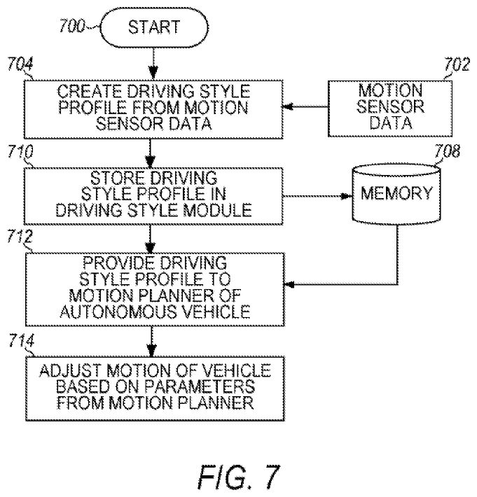

FIG. 7 illustrates a flow chart of a method of modifying operation of an autonomous vehicle by injecting driving style preference profile data of a passenger in accordance with a second sample embodiment. The illustrated process may be implemented entirely on processor 301 (FIG. 3) or the personalized driving style module 370 may be created off-line and communicated to the autonomous vehicle 310 for implementation of appropriate control operations. As illustrated, the process begins at 700 by collecting motion sensor data 702 relating to the driving habits of a driver to create a driving style preference profile of the driver at 704. The driving style preference profile is stored at 706 in a driving style module 708 and provided to the motion planner of an autonomous vehicle at 710 to modify operation of the autonomous vehicle upon injection of the driving style preference profile. The motion of the vehicle is then adjusted at 712 based on the parameters received from the motion planner. In this embodiment, the driving style module 708 may be injected into the motion planner during vehicle operation irrespective of the availability of the feedback operation provided in the embodiment of FIG. 6.

The system and methods described herein thus provides an increased level of comfort to passengers of autonomous vehicles by providing a degree of personalization for the riding experience. In various implementations, the autonomous vehicle manufacturers would provide a communications mechanism and/or a plug-in slot for the driving style module 370 so that the personalized parameters of the driving style model may be dynamically communicated to the motion planner 108 of the autonomous vehicle. Of course, the personal driving style module loading mechanism should have sufficient security precautions around an industry standard security protocol to securely inject the driving style parameters while simultaneously preventing the injection of improper data.

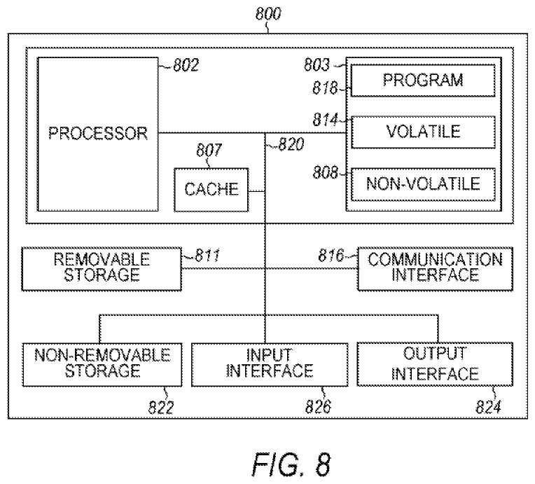

FIG. 8 is a block diagram illustrating circuitry in the form of a processing system for implementing the systems and methods of providing a personalized driving style module to an autonomous vehicle as described above with respect to FIGS. 1-7 according to sample embodiments. All components need not be used in various embodiments. One example computing device in the form of a computer 800 may include a processing unit 802, memory 803, cache 807, removable storage 811, and non-removable storage 822. Although the example computing device is illustrated and described as computer 800, the computing device may be in different forms in different embodiments. For example, the computing device may be the computer 300 of FIG. 3 or may instead be a smartphone, a tablet, smartwatch, or other computing device including the same or similar elements as illustrated and described with regard to FIG. 3. Devices, such as smartphones, tablets, and smartwatches, are generally collectively referred to as mobile devices or user equipment. Further, although the various data storage elements are illustrated as part of the computer 800, the storage may also or alternatively include cloud-based storage accessible via a network, such as the Internet or server-based storage.

Memory 803 may include volatile memory 814 and non-volatile memory 808. Computer 800 also may include—or have access to a computing environment that includes—a variety of computer-readable media, such as volatile memory 814 and non-volatile memory 808, removable storage 811 and non-removable storage 822. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 826, output interface 824, and a communication interface 816. Output interface 824 may include a display device, such as a touchscreen, that also may serve as an input device. The input interface 826 may include one or more of a touchscreen, touchpad, mouse, keyboard, camera, one or more device-specific buttons, one or more sensors integrated within or coupled via wired or wireless data connections to the computer 800, and other input devices. The computer 800 may operate in a networked environment using a communication connection to connect to one or more remote computers, which may include a personal computer (PC), server, router, network PC, a peer device or other common DFD network switch, or the like. The communication connection may include a Local Area Network (LAN), a Wide Area Network (WAN), cellular, Wi-Fi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software that, upon execution by the processing unit 802, performs the driving style operations according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed to be transitory. Storage can also include networked storage, such as a storage area network (SAN). Computer program 818 also may include instruction modules that upon processing cause processing unit 802 to perform one or more methods or algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

It should be further understood that software including one or more computer-executable instructions that facilitate processing and operations as described above with reference to any one or all of steps of the disclosure can be installed in and sold with one or more computing devices consistent with the disclosure. Alternatively, the software can be obtained and loaded into one or more computing devices, including obtaining the software through physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code or instructions to perform functions (e.g., by operating on input data and/or generating an output). Method steps can also be performed by, and apparatus for performing the methods can be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory or both. The required elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors 802, such that the instructions, upon execution by one or more processors 802 cause the one or more processors 802 to perform any one or more of the methodologies described herein. Accordingly, a “machine-readable medium” refers to a single storage apparatus or device, as well as “cloud-based” storage systems that include multiple storage apparatus or devices.

Those skilled in the art will appreciate that while sample embodiments have been described in connection with methods of providing driving style management for autonomous vehicles in a sample embodiment, the disclosure described herein is not so limited. For example, the techniques described herein may be used to collect and provide driving style preferences to vehicles that are only partially autonomous. For example, the driving style parameters may be stored and used to manage cruise control operations of standard non-autonomous vehicles.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Although the present disclosure has been described with reference to specific features and embodiments thereof, it is evident that various modifications and combinations can be made thereto without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A computer-implemented method of modifying operation of an autonomous vehicle based on a driving style decision-making model of a passenger, comprising:
a machine learning module for a motion planner of the autonomous vehicle accepting input relating to a driving style of the autonomous vehicle, the driving style input comprising data representing at least one of autonomous vehicle speed, acceleration, braking, and steering during operation;
the machine learning module of the motion planner of the autonomous vehicle receiving passenger feedback during operation, the passenger feedback relating to the driving style of the autonomous vehicle;
the passenger feedback training the machine learning module to create a personal driving style decision-making model for the passenger; and
controlling operation of the autonomous vehicle using the personal driving style decision-making model for the passenger.

2. The method of claim 1, wherein the passenger feedback is provided by at least one of voice, a touch screen, smart phone input, a vehicle interior sensor, and a wearable sensor on the passenger, and the passenger feedback relates to at least one of autonomous vehicle speed, acceleration, braking, and steering during operation and passenger comfort/discomfort during autonomous vehicle operation.

3. The method of claim 1, wherein the passenger feedback adjusts a cost function of the machine learning module.

4. The method of claim 1, further comprising the machine learning module receiving parameters of the personal driving style decision-making model from the passenger before or during operation of the autonomous vehicle and the machine learning module modifying the personal driving style decision-making model based on passenger feedback during operation of the autonomous vehicle.

5. The method of claim 4, further comprising recognizing a passenger in the autonomous vehicle and loading the parameters of the personal driving style decision-making model from the recognized passenger into the machine learning module.

6. The method of claim 4, wherein the parameters of the personal driving style decision-making model are stored in a memory storage device of the passenger and are communicated to the machine learning module from the memory storage device.

7. The method of claim 6, wherein the memory storage device comprises at least one of a key fob, a smart phone, and a cloud-based memory.

8. The method of claim 1, wherein the input relating to the driving style of the autonomous vehicle is obtained from a driving style preference profile of the passenger, the driving style preference profile generated for the passenger by collecting motion sensor data relating to driving habits of the passenger and storing the driving style preference profile for the passenger in a driving style module, the driving style preference profile from the driving style module being provided to the motion planner of the autonomous vehicle to modify operation of the autonomous vehicle in accordance with the driving style preference profile.

9. The method of claim 8, wherein the driving style preference profile of the passenger comprises data representing at least one of autonomous vehicle speed, acceleration, braking, and steering during operation.

10. An autonomous vehicle control system that modifies operation of an autonomous vehicle based on driving style preference profile of a passenger, comprising:
motion sensors that provide motion sensor data relating to driving habits of a driver;
a processor that creates a driving style preference profile of the driver from the motion sensor data;
a driving style module that stores the driving style preference profile; and
a motion planner that receives the driving style preference profile from the driving style module and modifies operation of the autonomous vehicle in accordance with the driving style preference profile.

11. The autonomous vehicle control system of claim 10, further comprising a machine learning module that accepts as input the driving style preference profile and input relating to a driving style of the autonomous vehicle, the driving style input comprising data representing at least one of autonomous vehicle speed, acceleration, braking, and steering during operation, the machine learning module further receiving passenger feedback during operation of the autonomous vehicle, the passenger feedback relating to the driving style of the autonomous vehicle, wherein the machine learning module is trained using the driving style preference profile and passenger feedback to create a personal driving style decision-making model for the passenger.

12. The autonomous vehicle control system of claim 11, further comprising an input device comprising at least one of a voice recognition device, a touch screen, a smart phone, a vehicle interior sensor, and a wearable sensor on the passenger, wherein feedback provided via the input device relates to at least one of autonomous vehicle speed, acceleration, braking, and steering during operation and passenger comfort/discomfort during autonomous vehicle operation.

13. The autonomous vehicle control system of claim 12, wherein the passenger feedback adjusts a cost function of the machine learning module.

14. The autonomous vehicle control system of claim 11, further comprising a sensor that recognizes a passenger in the autonomous vehicle and loads a driving style preference profile for the recognized passenger into the machine learning module.

15. The autonomous vehicle control system of claim 10, wherein the driving style module comprises at least one of a key fob, a smart phone, and a cloud-based memory that stores the driving style preference profile and communicates the driving style preference profile to the motion planner.

16. A non-transitory computer-readable medium storing computer instructions for modifying operation of an autonomous vehicle based on driving style preference profile of a passenger, that when executed by one or more processors, cause the one or more processors to perform the steps of:
collecting motion sensor data relating to driving habits of a driver to create a driving style preference profile of the driver;
storing the driving style preference profile in a driving style module; and
providing the driving style preference profile from the driving style module to a motion planner of the autonomous vehicle to modify operation of the autonomous vehicle in accordance with the driving style preference profile.

17. The medium of claim 16, further comprising instructions for implementing a machine learning module for the motion planner of the autonomous vehicle, the instructions, when processed by the one or more processors, causing the one or more processors to perform additional steps of accepting as input the driving style preference profile and input relating to a driving style of the autonomous vehicle, the driving style input comprising data representing at least one of autonomous vehicle speed, acceleration, braking, and steering during operation.

18. The medium of claim 17, further comprising instructions that, when processed by the one or more processors, cause the machine learning module of the motion planner of the autonomous vehicle to receive passenger feedback during operation and the passenger feedback relating to the driving style of the autonomous vehicle, and to train the machine learning module using the driving style preference profile and passenger feedback to create a personal driving style decision-making model for the passenger.

19. The medium of claim 18, further comprising instructions that, when processed by the one or more processors, cause the one or more processors to adjust a cost function of the machine learning module based on the passenger feedback relating to the driving style of the autonomous vehicle.

20. The medium of claim 18, further comprising instructions that, when processed by the one or more processors, cause the one or more processors to recognize a passenger in the autonomous vehicle and to load a driving style preference profile for the recognized passenger into the machine learning module.
